(19) United States
(12) Patent Application Publication
(10) Pub. No.: US 2007/0219917 A1
(43) Pub. Date: Sep. 20, 2007

(54) Digital License Sharing System and Method

(75) Inventors: Qiong Liu, North South Wales (AU); Reihaneh Safavi-Naini, North South Wales (AU); Nicholas Paul Sheppard, North South Wales (AU)

Correspondence Address: THELEN REID BROWN RAYSMAN & STEINER LLP, 900 THIRD AVENUE, NEW YORK, NY, 10022, US

(73) Assignee: SMART INTERNET TECNOOGY CRC PTY LIMITED, EVELEIGH, AUSTRALIA NSW (AU)

(21) Appl. No.: 10/599,517

(22) PCT Filed: Mar. 29, 2005
(86) PCT No.: PCT/AU05/00449

§ 371 Date: Sep. 29, 2006

(30) Foreign Application Priority Data
Mar. 29, 2004 (AU) 2004901684

(51) Int. Cl. H04L 9/32

(52) U.S. Cl. 705/59

(57) ABSTRACT

A digital license sharing method, system and apparatus is provided for use in a digital rights management system. Usage rights in respect of digital content are transferred between content player devices or applications by associating with each player a status indication. Transfer is carried out by transmitting a request to obtain the usage rights from a player requiring usage rights to a player currently holding the rights. The transferring player sets a first status indication to indicate that it is no longer entitled to exercise the rights, and transmits a response to the requesting player to transfer the usage rights. The requesting player then sets a second status indication to indicate that it is henceforth entitled to exercise the rights. Methods and apparatus for creating transferable licenses are also provided that employ a sharable license format including a validated portion and an unvalidated portion. The validated portion, which may be, for example, digitally signed by a license issuing authority, includes characteristic information of a digital content decryption key required to access the digital content controlled by the license. The unvalidated portion includes the digital content key itself, encrypted using an encryption key associated with a player entitled to use the license.

### FIELD OF THE INVENTION

The present invention relates to digital rights management, and in particular to a system and method for sharing a single digital license amongst multiple devices.

### BACKGROUND OF THE INVENTION

Today many service providers sell their digital content, such as digital music, images, video, books and games, over computer networks. To protect commercial digital intellectual property and avoid digital piracy, Digital Rights Management (DRM) systems are needed that can be used to prevent unauthorized access to digital content and manage content usage rights. The core concept in DRM is the use of digital licenses. A license is a digital data file that contains content decryption keys and content usage rules.

In DRM, rather than buying content directly, users purchase licenses that grant certain rights to the content. Usage rules specify how the content should be used, such as copy permission, pay-per-view, a one-week rental, and so on. A license can be described using a rights expressing language, such as extensible rights Markup Language (XrML) that was selected by the Moving Picture Expert Group (MPEG) for the MPEG-21 Multimedia Framework. Some use scenarios for the usage rules are described in the XrML specification document, eXtensible rights Markup Language (XrML) 2.0 Specification, ContentGuard, Nov. 20, 2001. However, the specification does not specify mechanisms to support these scenarios.

In current DRM implementations, encrypted content can be distributed using any communication medium, such as through a client/server system, super-distribution, digital audio/video broadcasting, or CDs, but without possession of a valid license, the content cannot be decrypted. The protected content can thus be distributed independently of any license. More specifically, when the user attempts to consume the protected content, the player device will check if there exists a valid license for the content on the user's device. If the player cannot find the license, it will refuse to grant access to the content, and prompt the user to contact the license server to acquire a valid license. After the user provides information and/or payment that may be necessary to obtain the license, the license will be delivered to the user's device, and the protected content can be decrypted and used according to the usage terms and conditions in the license.

In order to prevent digital piracy via transfer of rights, most existing DRM solutions bind licenses to a particular device. The license cannot be transferred and used on another device. For example, if a user wants to watch a purchased movie at an alternative location, or listen to music on a portable device, the user must acquire a new license for each device, which is inconvenient for the user.

One scheme that enables a license to be used by multiple devices is “broadcast encryption”. In broadcast encryption, the user needs to register all the devices he intends to use with the content provider. During license transfer, the sender does not need to modify the original license. Only legitimate devices can access the content key after receiving the license.

The disadvantage of using broadcast encryption is that new devices must be registered to the content provider. When the user replaces old devices with new ones, he wants to continue to use the content he has purchased. The new devices must receive a private key. If a device is compromised, the content provider must change the public key and update the private keys of all devices. Thus, the content provider will have to save and periodically update a record of the user and the device set. Moreover, if the user wants to subscribe content from different content providers, the user has to register his devices with each content provider, which is inconvenient for the user.

The License Management Service (LMS), as disclosed for example in Backing Up and Restoring of DRM Licenses, Microsoft Corporation, 2000-2003 uses a centralized server to manage the restoration of licenses in DRM. This service allows the user to transfer licenses to a new computer or back to the same computer after reformatting the hard disk, for example. The user must be connected to the Internet when the user tries to restore licences and a request from the application will be sent to the server.

Under LMS, the user is only allowed to restore a license to a limited number of computers. Each time a license is restored, the server tracks the number of computers to which a license has been restored. If a limit is reached, the user cannot restore the license. Microsoft does not publish the technical details of this service, however it is apparent that LMS does not provide a satisfactory solution to the problem of sharing a license among multiple devices while ensuring that only one device can use the license at a time.

The document Copy Prevention Scheme for Rights Trading Infrastructure, by Masayuki Terada and Hiroshi Kuno and Masayuki Hanadate and Ko Fujimura, NTT Laboratories, 2000, describes a generic copy prevention scheme for trading digital rights called FlexiToken. In this scheme, a digital right is represented using two types of information: the rights description object and the token object. The token object represents the “genuineness” of the rights object and is stored and circulated using tamper-proof devices such as smart cards. The rights object can be held in any storage medium, but to redeem the rights, the user must present the token of the rights to the service provider.

The security of this scheme depends on the assumption that secret keys are managed securely and that the tamper-proof capability of smart cards is not compromised. Thus, a digital right can be protected against alteration, forgery and reproduction.

To prevent repudiation of rights transfer, FlexiToken assumes that neither participant flees from the other, i.e. the sender deletes the token from the original card after receiving the receipt from the receiver. However, this assumption may be violated if the operation of this procedure is interrupted either intentionally or accidentally. For example, a dishonest user may terminate the transaction after transferring the rights token from one card to another without deleting the original one.

FlexiToken cannot be directly applied to DRM, because a digital license in DRM contains content keys, which need to be stored in a protected form. However, a rights object in FlexiToken does not contain content keys.

An alternative scheme, the Extensible Cluster Protocol (xCP), is described in the IBM corporate document, IBM Response to DVB-CPT Call for Proposals for Content Protection & Copy Management: xCP Cluster Protocol, 2001. In xCP, digital content is cryptographically bound to a network of devices in a “cluster”, which may be, for example, all of the devices in a user's household. Within a single cluster, digital content can be freely moved and copied from device to device, so that the consumer can access all the licensed content from these devices. The xCP Cluster Protocol prevents unauthorized content distribution outside of the cluster, for example from one household to another.

This protocol requires that each device have a unique set of device keys and that peers in a cluster share a common media key block and a cluster ID. Devices use device keys and the media key block to calculate a common key. This key value will be used to decrypt the encrypted content key embedded in the content file. The security of this protocol largely depends on the assumption that the media key block is securely stored in one of the devices in the cluster that acts as a server to authorize other devices.

Unlike most existing DRM systems in which digital content and licenses are stored and distributed separately, in the xCP scheme usage rules are stored in the clear parts of encrypted content, such as “copy once”, “copy no more”, and “copy never”. Time-based usage rules, such as an elapsed time condition or calendar-based permission, are supported based on the assumption that the server has a secure clock. Count-based usage rules, such as a fixed number of player devices, require that the server have a secure hardware counter that prevents the user from restoring an old counter value or resetting usage counts.

The xCP Cluster Protocol is a hardware-based solution. Thus, for example, if user A sells an xCP-compliant device to user B, then in order for the device to work in user B's cluster, a strategy must be provided to enable the device to be embedded with the cluster ID specific to B's home network.

U.S. Pat. No. 6,372,974, assigned to Intel Corp, describes a portable music player capable of transferring music files directly to another such player, i.e. without the intermediary of a PC or other intervening host. A method of transfer is disclosed that is capable of protecting digital rights by using a transfer protocol that results in the eventual deletion of the content on the sending player. Accordingly, the method is intended to ensure that only one copy of the content exists at any given time. However, the method does not provide support for more sophisticated DRM features, and in particular does not provide for a license that may include content usage rules, and that may exist independently of encrypted content.

Furthermore, it is not apparent from U.S. Pat. No. 6,372,974 that the method disclosed provides adequate protection against communications failures that may result from accidental or intentional disconnection of the players during transfer. Without suitable safeguards to ensure atomicity of transfers (i.e. that in all circumstances either all or none of the transaction's operations are performed), such disconnection may result in the user either losing access to a playable copy of the content, or illegitimately obtaining an additional copy of the content.

Published US Patent Application No. 2003/0004885, assigned to IBM Corp, describes a method for maintaining a chain of title when transferring digital property rights. The method consists in augmenting existing DRM information (e.g. a license) with additional fields identifying the current owner and ownership history. When the license is transferred, ownership is updated and digitally signed by the “seller”, after which only the “buyer” is permitted to consume the licensed content or to transfer the ownership again. However, the method is based on the assumption that a secure and reliable procedure for rights transfer is available, and the document does not disclose any particular scheme for achieving this. In particular, the IBM specification does not disclose a method for transferring a license, including a content decryption key, between two devices and without the intermediary of a license server.

U.S. Pat. No. 5,629,980, assigned to Xerox Corp, discloses a system for controlling the use and distribution of digital works. The system includes trusted storage locations known as “repositories” in which digital works controlled by DRM usage rights are held. Accordingly, all player devices, as well as devices such as content servers, include such repositories. Methods are provided for describing and implementing a broad spectrum of possible usage rights, including lending rights and differing levels of copying rights. However, no methods are disclosed that provide for the secure, efficient and flexible transfer of licenses independently of encrypted content, such that it would be possible to maintain multiple copies of the content in untrusted storage, for example on multiple devices owned by a single consumer, while allowing only a single device to hold a license authorising playback of the content using that device.

In summary, there is a need for a secure license-sharing system and method that allows a user to share a license among multiple devices while ensuring that only one device can use the license at a time.

It is desirable that a license-sharing method ensures that a digital right can be protected against alteration, forgery and reproduction, while providing for protected content keys so that the method may be applied directly to DRM.

Furthermore, it is a desired feature of a license-sharing scheme that it should not be unduly hardware dependent so that, for example, ownership of a player device may be transferred and/or physical location or connectivity of a device may be changed without requiring a specialised strategy to be employed to authorise the device for use by its new owner and/or in its new location.

It is also desirable to provide a license-sharing scheme that is able to ensure that there is always exactly one device that has a valid copy of a license at the end of a license transfer procedure, regardless of any communication failure between two players, i.e. that the transfer procedure satisfies the atomicity property.

Accordingly, it is an object of the present invention to mitigate the problems of the prior art by satisfying at least one of the aforementioned needs and desires.

It should be noted that any discussion of documents, devices, acts or knowledge in this specification is included to explain the context of the invention. It should not be taken as an admission that any of the material formed part of the prior art base or common general knowledge in the relevant art.

### SUMMARY OF THE INVENTION

The inventors have recognised that it is possible to separate a digital license that confers specific usage rights within a DRM system from an entitlement of any particular device to exercise the usage rights. In prior art schemes, the usage rights and entitlement to exercise those rights are generally bundled together in the digital license, resulting in the binding of the license itself to a single device. By separating the rights from the entitlement, the inventors provide a method that enables the license to be held by a plurality of devices, while making it possible to ensure that only one device at any one time is actually enabled to exercise the usage rights. The license is therefore not bound to a specific device, but rather may be held by an unrestricted number of devices, whereas the entitlement to exercise the usage rights may be held by only a single device at any given time.

Accordingly, in one aspect, the present invention provides, in a digital rights management system in which a digital license confers predetermined usage rights in relation to a digital content, a method of transferring the usage rights from a first content player application to a second content player application, including the steps of:

a) associating with the first content player application a first status indication with respect to the digital license for indicating whether the first player application is entitled to exercise the usage rights conferred by the license;

b) associating with the second content player application a second status indication with respect to the digital license for indicating whether the second player application is entitled to exercise the usage rights conferred by the license;

c) transmitting a request for transfer of the usage rights from the second player application to the first player application;

d) setting the first status indication to indicate that the first player application is no longer entitled to exercise the usage rights;

e) transmitting a response transferring the usage rights from the first player application to the second player application; and

f) setting the second status indication to indicate that the second application is henceforth entitled to exercise the usage rights;

wherein the steps (c) to (f) are carried out in the stated order.

Advantageously, the usage rights conferred by the license are thereby not bound to a single device or application, but may be transferred from one device to another, while at the same time ensuring that the license can only be used by a single device or application at any one time. Furthermore, the particular sequence of steps ensures that the transfer process is robust against intentional or unintentional failures of communication between the two applications, such that any interruption that occurs during the process cannot result in both applications simultaneously acquiring the usage rights conferred by the license.

Preferably, the first content player application executes on a first player device and the second content player application executes on a second player device. However, it will be appreciated that the two player applications may execute on a single device such as, for example, a general purpose PC.

It is preferable that prior to the transfer, the first status indication indicates that the first content player application is entitled to exercise the usage rights. Clearly, if this is not the case no transfer of the rights can occur. It is also preferred that prior to the transfer, the second status indication indicates that the second content player application is not entitled to exercise the usage rights.

In preferred embodiments, the step (e) must be successfully completed within a predetermined time following the completion of step (c), otherwise the transfer is aborted. Advantageously, the inclusion of such a timeout in the method ensures that a failure of communication between the two applications does not result in a deadlock of one or both applications.

Step (e) may also include transmitting the digital license from the first player application to the second player application. This is particularly advantageous if the second player application does not already have the license, since the second application is thereby immediately enabled to exercise the usage rights with respect to the digital content without the need to separately acquire the license itself.

Step (c) may include, after transmitting the request, setting the second status indication to indicate that transfer of the usage rights has been requested. Transmitting the request may include transmitting a request message from the second application to the first application, wherein the message includes the value of the second status indication. Accordingly, if the transfer is subsequently aborted after step (d) then the first and second status indicators will indicate that the second application has requested the usage rights whereas the first application is no longer entitled to exercise the usage rights. Advantageously, the applications are thereby able to verify that the transfer was aborted and negotiate for completion of the transfer of rights to the second application.

Preferably, the first and second status indications are implemented as transaction flags in first and second tracking files associated with the first and second content player applications respectively. The transaction flags may be associated with the digital license by using a unique license identifier stored within the license as an index in the tracking file. Advantageously this enables each tracking file to store transaction flags associated with multiple digital licenses. It is further preferred that each entry in each tracking file includes a time stamp indicating when the license was last transferred to or from the corresponding application.

In a preferred embodiment, the method further includes computing an authentication code that is a function of the values of all transaction flags in the tracking file each time any transaction flag in the tracking file is altered. The authentication code may be computed as a one-way hash function of the concatenated values of all of the transaction flags. Preferably a secret key is associated with each of the first and second content player applications, and the value of the secret key is concatenated with the transaction flags before computing the hash function. Advantageously this prevents a malicious user from modifying the value of a transaction flag in the tracking file and recomputing the authentication code.

In a particularly preferred embodiment, a secure monotonic counter is associated with each content player application that is incremented each time any transaction flag in the tracking file is altered, and the value of the counter is concatenated with the secret key and the transaction flags before computing the hash function. This protects the tracking file against replay attack.

Preferably, the steps of the method are executed in a tamper resistant secure computing environment including secure storage, and the secret key is held only within said secure storage.

In another aspect, the present invention provides, in a digital rights management system in which a digital license confers predetermined usage rights in relation to a digital content, a system for transferring the usage rights from a first content player application to a second content player application, including:

request transmitting means adapted to transmit a request for transfer of the usage rights from the second player application to the first player application;

first indication setting means adapted to set a first status indication associated with said first content player application to indicate that the first player application is no longer entitled to exercise the usage rights;

response transmitting means adapted to transmit a response transferring the usage rights from the first player application to the second player application; and

second indication setting means adapted to set a second status indication associated with said second content player application to indicate that the second application is henceforth entitled to exercise the usage rights.

Preferably, the request transmitting means includes computer software code including instructions to effect transmission of a request for transfer of the usage rights from the second player application to the first player application, the first indication setting means includes computer software code including instructions to effect the setting of said first status indication to indicate that the first player application is no longer entitled to exercise the usage rights, the response transmitting means includes computer software code including instructions to effect transmission of a response transferring the usage rights from the first player application to the second player application, and the second indication setting means includes computer software code including instructions to effect the setting of said second status indication to indicate that the second application is henceforth entitled to exercise the usage rights.

In another aspect, the present invention provides, in a digital rights management system, a method for generating a second digital license from a first digital license, wherein said first digital license confers predetermined usage rights in relation to a digital content upon a first digital content player application and said second digital license confers the usage rights upon a second digital content player application, said digital content being normally encrypted and only able to be decrypted using a digital content decryption key, the first and second digital licenses each including a validated portion and an unvalidated portion, wherein

the validated portion of the first digital license includes characteristic information of the digital content decryption key, and

the unvalidated portion of the first digital license includes the digital content decryption key encrypted using an encryption key associated with said first digital content player application,

the method including the steps of:

decrypting the digital content decryption key using a decryption key associated with the first digital content player application;

using the decrypted digital content decryption key to generate the characteristic information of the digital content decryption key;

verifying that the generated characteristic information matches the characteristic information included in the validated portion of the first digital license; and

if the verification is successful, encrypting the digital content decryption key using an encryption key associated with said second digital content player application and including said encrypted key in the unvalidated portion of the second digital license.

Advantageously, the method enables a license that was originally issued for use by the first player application to be transferred to the second player application without the need to contact the license issuer or other authority to obtain a new license for use with the second player. Accordingly, it is possible to transfer the license while offline, since no connection to an outside license server is required.

Preferably, the validated portion of the first digital license is validated using a digital signature of a trusted authority. The trusted authority may be, for example, a license issuer. The validated portion may further include information relating to the usage rights conferred upon the player application. Preferably, the validated portion also includes a unique license identifier.

It is preferred that the encryption and decryption keys associated with the first digital content player application are the public and private keys respectively of a first public/private key pair. It is also preferred that the encryption key associated with the second digital content player application is the public key of a second public/private key pair.

In preferred embodiments, the method may include the step of verifying that the validated portion of the digital license has not been altered or falsified, and that the license has been legitimately acquired from the license issuer, for example by verifying that the digital signature is correct with respect to the issuer and the contents of the validated portion of the license. Accordingly, if an attempt has been made to alter the license, for example to confer additional rights, or to forge a license, the player application may reject the license.

It is preferred that the validated portion of the digital license includes characteristic information of the encrypted digital content, for example a hash of the encrypted digital content. Accordingly, the method may further include the steps of generating the characteristic information of the encrypted digital content and verifying that the generated characteristic information matches the corresponding information included in the validated portion of the digital license. Advantageously, this enables a content player application to verify that the digital license corresponds with the digital content.

The characteristic information of the digital content decryption key is preferably a hash of the digital content decryption key. In particularly preferred embodiments, a one-way, collision-free and pre-image resistant hash function is used, such that it is very unlikely that any two content decryption keys will have the same hash value.

It is preferred that the device upon which the first digital content player application executes provides a tamper resistant secure computing environment including secure storage, and that the decrypted digital content decryption key and the private key of the first digital content player application are held only within said secure storage.

In a further aspect, the present invention provides, in a digital rights management system in which a digital license confers predetermined usage rights in relation to a digital content, a method of a first digital content player device transferring the usage rights to a second digital content player device, including the steps of:

a) receiving a request from the second player application to transfer the usage rights from the first player application to the second player application;

b) setting a first status indication to indicate that the first player application is no longer entitled to exercise the usage rights conferred by the license; and

c) transmitting a response transferring the usage rights from the first player application to the second player application, whereby upon receipt of said response the second player application sets a second status indication to indicate that the second player application is henceforth entitled to exercise the usage rights,

wherein the steps (a) to (c) are carried out in the stated order. In still a further aspect, the present invention provides, in a digital rights management system in which a digital license confers predetermined usage rights in relation to a digital content, a method of a second digital content player device transferring the usage rights from a first digital content player device, including the steps of:

a) transmitting a request to the first content player device to transfer the usage rights to the second content player device, whereby the first device sets a first status indication to indicate that the first device is no longer entitled to exercise the usage rights conferred by the license;

b) receiving a response transferring the usage rights from the first content player device to the second content player device; and

c) setting a second status indication to indicate that the second content player device is henceforth entitled to exercise the usage rights;

wherein the steps (a) to (c) are carried out in the stated order.

In another aspect, the present invention provides a digital content player device for use in a digital rights management system in which a digital license confers predetermined usage rights in relation to a digital content, the device including:

request transmitting means adapted to transmit a request for transfer of the usage rights from another device to said digital content player device;

response transmitting means adapted to transmit a response to a request for transfer of the usage rights received by said digital content player device from another device;

request receiving means for receiving a request for transfer of the usage rights by said digital content player device from another device;

response receiving means for receiving a response by said digital content player device from another device to a transmitted request for transfer of the usage rights; and

indication setting means adapted to set a status indication to indicate that said digital content player device is entitled to exercise the usage rights when the rights are transferred to the digital content player device, and to indicate that the digital content player device is not entitled to execute the usage rights when the rights have not been transferred to the digital content player device.

In yet another aspect, the present invention provides, in a digital rights management system, an apparatus for generating a second digital license from a first digital license, wherein said first digital license confers predetermined usage rights in relation to a digital content upon a first digital content player application and said second digital license confers the usage rights upon a second digital content player application, said digital content being normally encrypted and only able to be decrypted using a digital content decryption key, the first and second digital licenses each including a validated portion and an unvalidated portion, wherein

the validated portion of the first digital license includes characteristic information of the digital content decryption key, and

the unvalidated portion of the first digital license includes the digital content decryption key encrypted using an encryption key associated with said first digital content player application,

the apparatus including:

decrypting means adapted to decrypt the digital content decryption key using a decryption key associated with the first digital content player application;

generating means adapted to use the decrypted digital content decryption key to generate the characteristic information of the digital content decryption key;

verifying means adapted to verify that the generated characteristic information matches the characteristic information included in the validated portion of the first digital license; and

encrypting means adapted to check if the verification is successful, and if so then to encrypt the digital content decryption key using an encryption key associated with said second digital content player application and to include said encrypted key in the unvalidated portion of the second digital license.

Preferably, the decrypting means includes computer software code including instructions to effect decryption of the digital content decryption key, the generating means includes computer software code including instructions to effect generation of the characteristic information of the digital content decryption key, the verifying means includes computer software code including instructions to verify that the generated characteristic information matches the characteristic information included in the validated portion of the first digital license, and the encrypting means include computer software code including instructions to check if the verification is successful, and if so then to effect encryption of the digital content decryption key using an encryption key associated with said second digital content player application and including said encrypted key in the unvalidated portion of the second digital license.

In order that the invention might be more fully understood, embodiments of the invention will be described with reference to the accompanying drawings. Further optional and preferred features and advantages of the methods and systems of the present invention will become apparent from the following description of these preferred embodiments. However, the embodiments described herein below should not be considered as limiting the scope of the invention or any of the preceding statements.

### BRIEF DESCRIPTION OF THE DRAWINGS

FIG. 1 is a schematic diagram of digital rights management system according to a preferred embodiment of the invention;

FIG. 2 is an illustration of an arrangement that may be employed by a malicious user to gain unauthorised access to a license;

FIG. 3 is a flow chart illustrating an exemplary license transfer procedure according to a preferred embodiment of the invention;

FIG. 4 is a flow chart illustrating a license recovery procedure according to a preferred embodiment of the invention;

FIG. 5 is a schematic illustration of an exemplary digital license according to the invention;

FIG. 6 is a flow chart illustrating a method of generating a transferable digital license according to the invention; and

FIG. 7 is a schematic illustration of an exemplary track file entry according to the invention.

### DESCRIPTION OF PREFERRED EMBODIMENTS

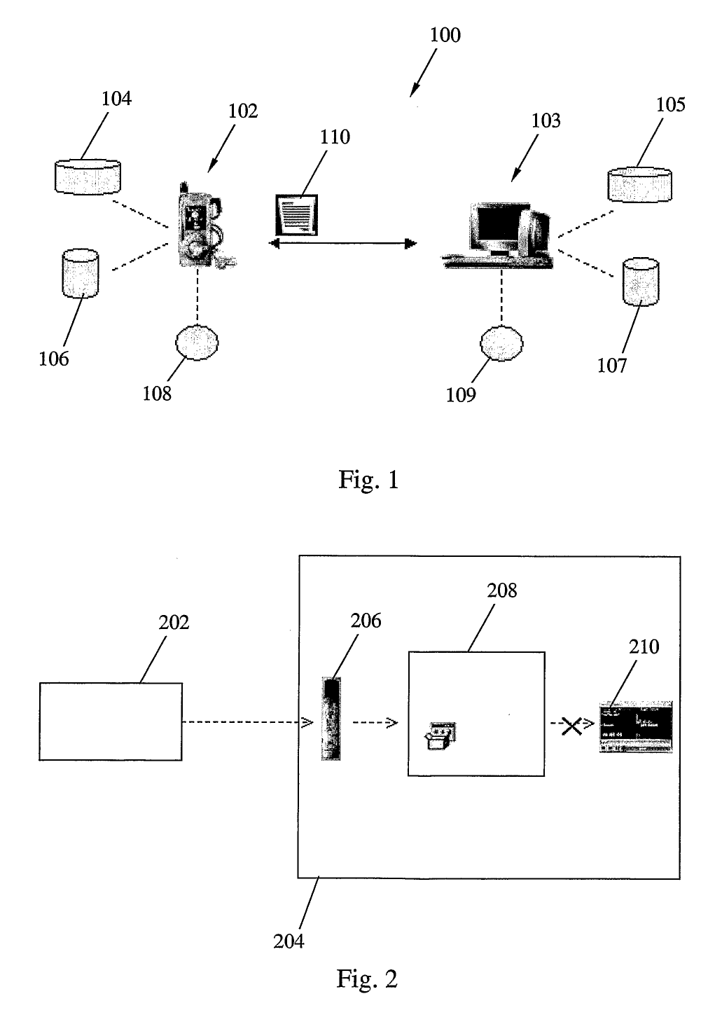

FIG. 1 is a schematic diagram of a digital rights management system 100 according to a preferred embodiment of the invention. The system includes two trusted player devices 102, 103, each of which includes a digital library 104, 105, a license database 106, 107 and a secure hardware counter 108, 109. Each player device 102, 103 may be, for example, a portable music player, a digital video player, or a general purpose personal computer with installed software and hardware enabling it to be used to reproduce or display digital content.

Each license database 106, 107 is a conceptual database, such as a file directory, on the respective device, which stores all licenses in a protected form and further includes a transaction track file that maintains a record of transaction flags of these licenses. Each digital library 104, 105 is a digital content repository on the user's device that stores digital items in a protected form. To decrypt and use content, there must be a valid license with a valid transaction flag in the license database 106, 107. Each counter 108, 109 is a secure, monotonically increasing hardware counter that can be used to prevent replay attack. It will be incremented by one each time a license transfer happens. The player is a viewer responsible for content decryption and playback, and for providing an interface with which the user can request/transfer a license from/to another device.

In one exemplary use scenario of the system, the user has acquired a license 110 from a license server and may have stored the license on a home PC, for example. If the user wishes to consume the content on multiple devices 102, 103, the license must be transferred to the appropriate device. Transfer of a license may occur directly between the devices via a network connection such as a TCP/IP LAN, or a wireless connection such as an infrared link or a Bluetooth or 802.11 radio frequency link. Alternatively, transfer of a license may be through the intermediary of a mobile phone or other handheld device with wireless connections. Since the user may carry a mobile phone or other handheld device wherever he goes, using such a device to facilitate license transfer enhances the convenience of the system.

In the license sharing system and method of the invention, reliance is made upon a number of assumptions, as follows:
A1. DRM protected content can be copied and distributed to any device. Note that such protected content cannot be consumed if there is no valid license on the device.
A2. License transfers take place between two trusted player applications. A player is trusted if it enforces content usage rights with respect to the license.
A3. Each trusted player has a public/private key pair and an authentication key. A trusted player's private key and authentication key are securely stored on a secure memory of the user's device, so that the user does not have any knowledge of these keys at any time.
A4. The trusted player executes in a secure computing environment, and a malicious user cannot gain the content key and unprotected content when the content is being decrypted.
A5. The trusted player application is tamper-resistant, i.e. it is impossible for the user to reverse engineer and tamper the software.
A6. There exist secure audio paths between the trusted player and the display card and between the trusted player and I/O card. This assumption ensures that protected content files remain protected until the content reaches the output device.

It will be appreciated by those skilled in the art that the foregoing assumptions are generally satisfied in a number of known devices and systems implementing DRM, and can be achieved using known technologies and methods. Accordingly, these assumptions are not limiting of the present invention.

The system embodiment of FIG. 1 satisfies a number of requirements in transferring a license from the first player 102 to the second player 103, as follows:
R1. The digital license must be kept on the user's device in a protected form. This is because the license contains content decryption keys that should be hidden from the user.
R2. The license transfer procedure must ensure that only authorised player applications can access the license. A potential threat is that all the nearby devices of a device may get the signal through wireless (or PC) broadcasting when the license is sent out from the device.
R3. The license must be protected against unauthorized modification, interception and illegal forgery during transaction. FIG. 2 illustrates one arrangement that a malicious user may try to employ in order to gain unauthorised access to a license. A license is sent from a first device 202 to a second device 204, such as a general purpose PC. The license data is received via the network interface hardware 206, and processed by a network interface device driver software component 208 installed within the operating system of the device 204. An unmodified device driver would pass the license data to the player application 210 without examining or processing its contents. However, the potential threat is that the user may modify the driver software 208 on the device 204 so that the driver 208 may modify or block the received license, or even illegally forge a license.
R4. The license transfer procedure must satisfy the atomicity property. Atomicity is: “Either all or none of the transaction's operations are performed. If a transaction is interrupted by failure, then partial changes are undone”. Atomicity in the license transfer procedure is to ensure that only one device has a valid copy of the license at the end of the transfer procedure regardless of any communication failure between two players.

Each of the two trusted player devices 102, 103 in FIG. 1 has a copy of the DRM protected content. A license is to be transferred between the two players. The players manage license transfers and storage. Each device keeps a transaction track file for the purpose of license transfer. Each license known to the player has a corresponding data entry in the track file that contains a transaction flag of the license. Only the player can validate the integrity of the track file using its authentication key and read the records in the file. There are four types of transaction flags for the license: Active, Deactivated, Request and Recover. The meaning of these flags are described as follows:
Active: the license can be used by the player to decrypt the content;
Deactivated: the licence is deactivated, so the player cannot use it;
Request: the license is requested by one player application to another; and
Recover: the transaction flag of the license is requested to be set to ‘Active’ by one player application to another.

Each device can have a copy of the license, but only the license with ‘Active’ flag can be used by the player application to decrypt the content.

According to the present example, A and B are two trusted player applications executing on the devices 102 and 103 respectively. It will be appreciated by those skilled in the art that in a practical implementation of the transfer protocol it will typically be necessary for A and B to establish a suitable communications channel or session prior to commencing the transfer of rights, such as, for example, an authenticated session to ensure that both devices are trusted.

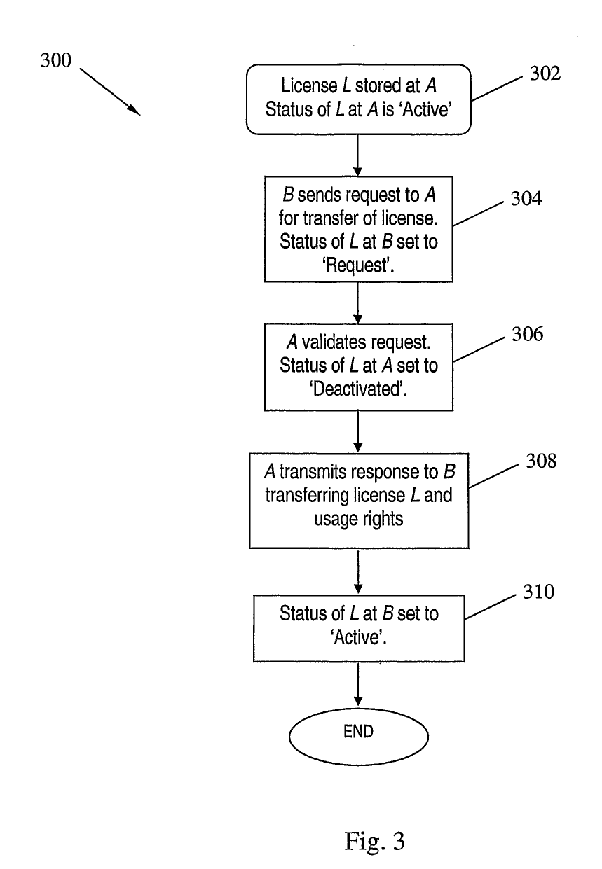

IDL is license L's identifier. Req(A, B, L) is the license request that application B sends to A for license L. T is a timeout value of the protocol. FIG. 3 shows a flow chart 300 of the steps completed in an exemplary license transfer scenario. Prior to the transfer, the initial conditions 302 are as follows: license L is stored on the hard disk of the device 102 on which application A executes; the transaction flag for L is ‘Active’; and A and B have established a suitable communications channel as described above. Application B executing on player 103 requests the ‘Active’ license L from A:

Step 304: B→A: Req(A, B, L), B writes (ID_{L}, ‘Flag=Request’)

Steps 306, 308: If Req(A, B, L)=valid, A writes (ID_{L}, ‘Flag=Deactivated’) (step 306), A→B: L (step 308); Else, A quits after timeout (T).

Step 310: If L is valid, B stores L and writes (ID_{L}, ‘Flag=Active’); Else, B quits after timeout (T).

In step 304, B writes (ID_{L}, ‘Flag=Request’) as the entry for L in its transaction track file. The transaction flag ‘Flag=Request’ reflects the current transaction state of L, that is, that application B has requested the active license. At this time L's entry in the transaction track file on application A's device 102 is (ID_{L}, ‘Flag=Active’).

In step 306, A receives and verifies the license request from B. If the request is found to be valid, A writes (ID_{L}, ‘Flag=Deactivated’) as the entry for L in its transaction track file, and in step 308 sends license L to B. Here, ‘Flag=Deactivated’ indicates that the license cannot be used any more, although L is still physically kept on A's device, i.e. A will refuse to use L to decrypt the content if A finds that L is marked as deactivated in the transaction track file. If A does not receive Req(A, B, L) within time T after establishing a suitable communications channel or the verification fails, A quits the transaction.

In step 310, B receives and verifies L from A. If L is found to be valid, B stores L and sets the transaction flag for L as ‘Active’, i.e. the entry for L in B's transaction track file becomes (ID_{L}, ‘Flag=Active’). Otherwise, if the verification fails or B does not receive the license from A within time T after sending Req(A, B, L), B quits the transaction. Application B may then attempt to request the license again, starting from step 304.

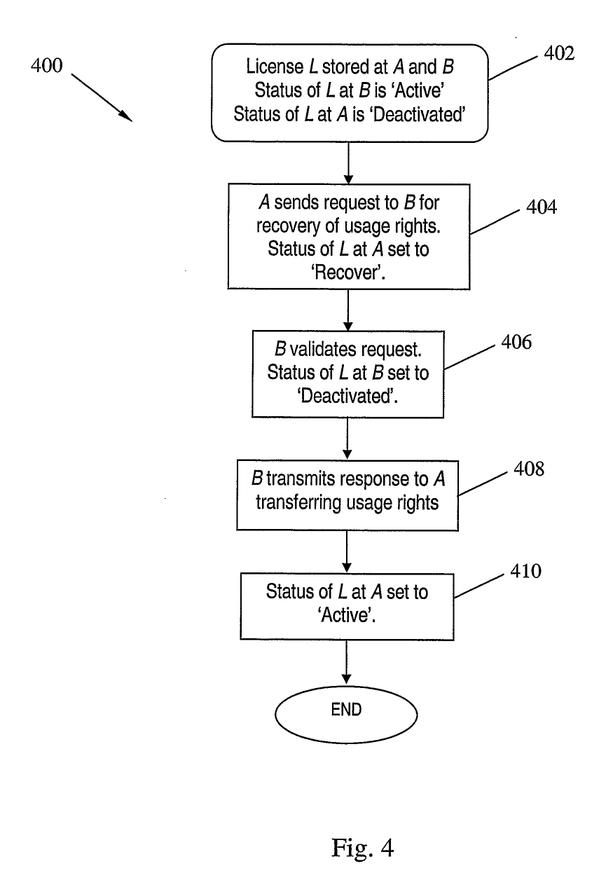

Preferably a license recovery protocol is implemented that is similar to the license transfer procedure. FIG. 4 shows a flow chart 400 of the steps completed in a license recovery scenario. Prior to recovery, the initial conditions 402 are as follows: both A and B have a copy of the licence L on their hard disks; and the transaction flag for L is ‘Active’ on B's device, but is ‘Deactivated’ on A's device. A requests that L's transaction flag on its device to be set to ‘Active’.

In this procedure, at step 404 instead of writing (ID_{L}, ‘Flag=Request’), A writes (ID_{L}, ‘Flag=Recover’) as the entry for L in its transaction track file after sending license recovery request to B. The transaction flag ‘Recover’ indicates that L is physically stored on A's hard disk but cannot be used, and A requests the ‘Active’ flag for L from B. At step 406, after B receives and verifies A's license recovery request, it will set the transaction flag for L on its device from ‘Active’ to ‘Deactivated’, and at step 408 will send a respond message to A. B will not be able to use the license. At step 410, the entry for L in A's transaction track file will become (ID_{L}, ‘Flag=Active’), so L can then be used by A to decrypt the content.

It is to be noted that the difference between the license recovery procedure and the license request procedure is that in license recovery, A already has a copy of the license L that is known by A to be valid, and thus it is not necessary for B to send L to A, or for A to verify the license.

In known DRM implementations, a license contains content usage rules and the content key. When the license is distributed from the license server to the user's device, the content key should not be transferred in clear text. Usually, the license issuer encrypts the content key with the public key of the player on the user's device. Each player application has a unique public/private key pair, thus each license is generated uniquely for a specific player on the user's machine. For example, in the DRM scheme described in the document Architecture of Windows Media Rights Manager published by Microsoft Corporation, 2003, the protected content key and usage rights are grouped in a license that is signed by the license issuer with its private key. This is to ensure that the license has not been tampered with and to prove that the license was purchased from the issuer.

The disadvantage of this scheme is that the license can only be used by the player application to which it was issued. In order to consume the content on a different player, the user must request or purchase a further license. In at least preferred embodiments, the present invention provides a license structure that may be employed to avoid this disadvantage, and thus enable the direct transfer of a license between devices.

The trusted player has a public key PUB_P and corresponding private key PRI_P. The license issuer has a public key PUB_I and corresponding private key PRI_I. The license issuer generates a license L that includes metadata for the content and the content key CK encrypted with player's public key and usage rules, and then signs the license with its private key. That is, the issuer generates a signed license as follows:
Signed L=L∥S_{PRI}_{_{—}}_{I}(L)
L=Metadata∥E_{PUB}_{_{—}}_{P}(CK)∥Usage Rules
where S( ) is a signature algorithm, E( ) is an asymmetric encryption algorithm, and ‘∥’ denotes concatenation. The signed license may then be delivered to the trusted player over a public channel.

However, a potential problem arises if the above approach is used to encrypt the content key and construct the license. Suppose that A and B are two trusted player applications. Their public keys can be denoted as PUB_A and PUB_B respectively. Player A has the license L containing encrypted content key E_{PU}_{_{—}}_{A}(CK) signed by the issuer I using PRI_I. A is to transfer the license to B.

Before the transfer procedure, A needs use its private key to decrypt the encrypted content key and then re-encrypt the content key using player B's public key. That is, A must generate E_{PUB}_{_{—}}_{B}(CK) and use it to replace E_{PUB}_{_{—}}_{A}(CK) in L so that B can decrypt and get the content key once the license is transferred from A to B. The problem in this scenario is that the license integrity will be compromised, because of the change in the encrypted content key part in the license is from E_{PUB}_{_{—}}_{A}(CK) to E_{PUB}_{_{—}}_{B}(CK). When player B checks the integrity of the license according to the license issuer's signature, the verification will fail, since when the license was signed it contained E_{PUB}_{_{—}}_{A}(CK).

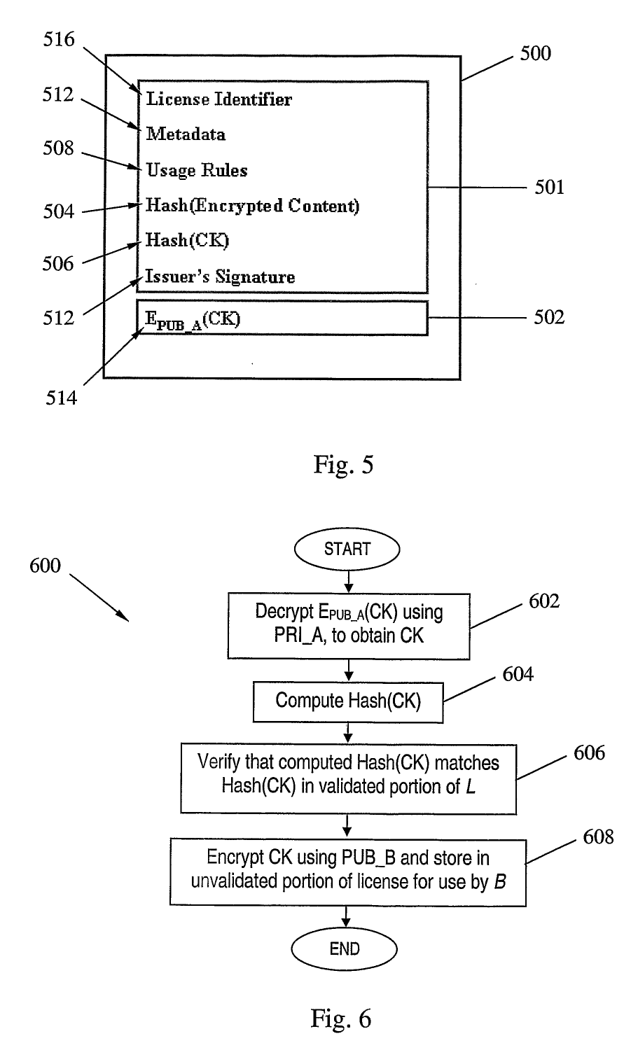

A new license structure is therefore proposed for use with preferred embodiments of the invention. FIG. 5 illustrates schematically a license 500 according to a preferred embodiment in which the license is split into two parts 501, 502. The first part 501 of the license 500 is a validated portion that includes: a cryptographic hash 504 of the encrypted content, the hash value 506 of the content key, the usage rules 508, and metadata 510. The second part 502 of the license 500 is an unvalidated portion that includes the content key encrypted with the public key of the player application 514. The first part of the license is digitally signed 512 by the issuer to enable its integrity and authenticity to be verified. The reason for constructing the license in this way is to prevent usage rules from unauthorized modification and to ensure that the issuer's signature will work properly when the content key is encrypted with another player's public key during license transfers.

The question arises as to what happens in the case of a dispute when the user claims that the license issuer put the wrong content key in the license? To avoid such dispute, the hash function is preferably one-way, collision-free and pre-image resistant, so it would be very unlikely that the license issuer will generate two content keys with the same hash value.

When a player receives the license, it will:
verify the signature 512 of the first part of the license;
verify the hash 504 of the content;
decrypt the encrypted content key 506 using its private key; and
pass the value of the key to the hash function.
   If the computed result is the same as the hash value 506 contained in the license, the player will accept the license. Otherwise, the license will be rejected and the player will contact the license server for license reissue. If the license is accepted but the key cannot be used to decrypt the content, the license issuer needs to reissue the license that contains the correct content key.

To uniquely identify a license, a licence identifier 516 may be included in the first part of the license. Before decrypting the content, the player needs to find the corresponding entry in the transaction track file, which may be done by using the unique license identifier 516 as a key in the track file. If the transaction flag of the license is ‘Active’, the player will be permitted to use the content key to decrypt the content.

FIG. 6 shows a flow chart 600 of an exemplary procedure followed by a device or application A for creating a second digital license for use by another device or application B, wherein both licenses are based upon the new license structure 500 illustrated in FIG. 5. At step 602, A obtains the content key CK by decrypting E_{PUB}_{_{—}}_{A}(CK) using its corresponding private key PRI_A. The hash value of CK, Hash(CK), is computed at step 604, and is then compared with the value of Hash(CK) 506 stored within the validated portion 501 of the license 500. Once the validity of CK has been verified in this way, at step 608 A encrypts CK using B's public key PUB_B, and stores the resulting value, E_{PUB}_{_{—}}_{B}(CK) within the unvalidated portion 502 of a copy of the license that is to be transmitted to B.

The second license generated according to the process 600 may then be verified, used, and regenerated by B in exactly the same manner as the original license is used by A.

The discussion now turns to a more detailed description of the format of the transaction track file. The transaction track file keeps a record of the current transaction state of the licenses on the user's machine. When the license is delivered to the user's device for the first time, the player application will write an entry for the license to the track file if the license integrity is verified.

To prevent track entries from undetectable manipulation or deletion, in the exemplary embodiment a Message Authentication Code (MAC) is attached to the file based on a secret key held by the player. Each license must have a unique entry in the track file that contains the transaction flag of the license. Every time the player updates a track entry, it increments the secure monotonic counter, e.g. 108, 109, and includes the counter value in the MAC with the file. If the license is physically deleted from the hard disk, its track entry will be deleted and the MAC will be updated automatically. If the license is physically stored on the hard disk of the device but there is no track entry for that license, the player will detect unauthorised deletion of the track entry and refuse to transfer the license to another device.

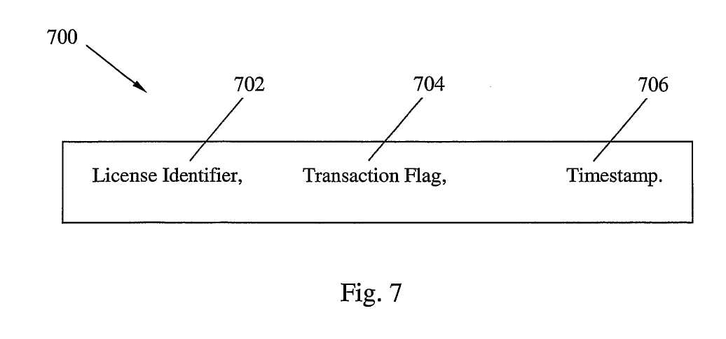

FIG. 7 illustrates the format of an exemplary track file entry 700, including a unique license identifier 702, a transaction flag 704, and a timestamp 706 that is maintained to reflect the last time the entry 700 was updated.

If the license identifier 702 in the track entry 700 matches with the license identifier 516 in a license, then the track entry corresponds to the license. In the exemplary embodiment described herein there are four types of transaction flags: ‘Active’, ‘Deactivated’, ‘Request’ and ‘Recover’. The timestamp 706 records the time when a transfer of the corresponding license last occurred, and hence is the time at which the transaction flag was last updated.

A MAC based on a secret key is used to prevent unauthorised tampering of the track file. In the exemplary embodiment, the player's authentication key is used for MAC computation. Suppose that the authentication key is K and T_{I} (i=1, 2, . . . , n) is the ith entry of the track file, then the value of the MAC is:
MAC=H(K∥CounterValue∥T₁∥T₂∥ . . . ∥Tₙ)
where H( ) is a one-way hash function and ∥ denotes concatenation.

The transaction track file is different from an audit log as described in the literature of the art. According to the definition of “log” provided in M Ruffin, A Survey of Logging Uses, University of Glasgow (Scotland), Fide2 Report 94-82, February 1994, “a log is an append-only write store and is a plain file where data are stored sequentially as they arrive”. In the exemplary embodiment, there is only one entry in the track file for a license with a specific license identifier. When the license is distributed to the user's device for the first time, the player will create a new data entry for the license. The transaction flag for this license will be set to ‘Active’. When a license transfer happens, the player will read the license identifier in the transferred license first and then search for the position of the entry for the license in the track file according to the identifier. The player will update the transaction flag and the timestamp of the license in the track entry after the license has been transferred to another device.

The security properties of the preferred embodiment of the invention are analysed below by reference to the requirements R1-R4.

Requirement R1 is satisfied, i.e. content keys in the licenses are kept in encrypted form on the user's device. Only the player application can decrypt encrypted content key using its private key.

Requirement R2 is satisfied. Unauthorised player applications will not be able to gain access to a license through wireless or PC broadcasting, or through any other form of eavesdropping of the communications links between devices or applications, because the content key in the license is sent to an authorised recipient B in an encrypted form using B's public key. Only B has the knowledge of the corresponding private key and thus only B is able to decrypt the encrypted content key.

Requirement R3 is satisfied. Unauthorised modification, forgery and interception of the license can be prevented, because the integrity of the usage rules can be verified according to the issuer's digital signature in the license.

Requirement R4 is satisfied. After a license transfer procedure takes place, only one device has the license with ‘Active’ flag. This property is analysed for a number of specific cases of license transfer from player application A to player application B, as follows.

Case 1: There is no communication problem between A and B. Exchanged messages are not disrupted by an attacker.

The protocol runs successfully. At the end of the license transfer, only B possesses the license, and has a corresponding track file entry with the ‘Active’ flag.

Case 2: A fails to receive the license request from B in step 2.

The protocol aborts after time out T. B does not obtain the license. L is still kept on A's device. The transaction entry for L on A's device is unchanged.

Case 3: B fails to receive the license from A in step 3.

The protocol aborts after time out T. The transaction flag for L in the track file on A's device is marked as deactivated, so A cannot use L any more. However, B can get the license from A through a negotiation procedure, i.e. B sends the licence request to A again, starting from step 1. This licence request needs to include the current transaction flag of L in the track file on B, which should be ‘Request’. A will check the license request in the negotiation procedure. Since L is still physically stored on A's device, A will send L to B again if the verification is successful. Finally, B will get license L and set the transaction flag for L as ‘Active’, so that B cannot send a valid license request to A again.

Moreover, the inventive system can prevent replay attack. Suppose that a malicious user has some licenses with ‘Active’ flag on his device. The user may take a snapshot of the current state of the track file, perform one or more license transfers to another device and finally restore the snapshot, removing all records that reflect license transactions since the snapshot. However, the player is able to detect this attack because the secure counter is incremented once for each transfer. Upon the user restoring the snapshot of the track file, the counter cannot be restored by the user to its value prior to the transactions. Accordingly, the calculated MAC value will be inconsistent with the restored MAC value, due to the changed counter value.

1. In a digital rights management system in which a digital license confers predetermined usage rights in relation to a digital content, a method of transferring the usage rights from a first content player application to a second content player application, including the steps of:
a) associating with the first content player application a first status indication with respect to the digital license for indicating whether the first player application is entitled to exercise the usage rights conferred by the license;
b) associating with the second content player application a second status indication with respect to the digital license for indicating whether the second player application is entitled to exercise the usage rights conferred by the license;
c) transmitting a request for transfer of the usage rights from the second player application to the first player application;
d) setting the first status indication to indicate that the first player application is no longer entitled to exercise the usage rights;
e) transmitting a response transferring the usage rights from the first player application to the second player application; and
f) setting the second status indication to indicate that the second application is henceforth entitled to exercise the usage rights,
wherein the steps (c) to (f) are carried out in the stated order.

2. The method of claim 1, wherein the first content player application executes on a first player device and the second content player application executes on a second player device.

3. The method of claim 1, wherein prior to the step (c) of transmitting a request, the first status indication indicates that the first content player application is entitled to exercise the usage rights.

4. The method of claim 1, wherein if the step (e) of transmitting a response is not successfully completed within a predetermined time following the completion of the step (c) of transmitting a request, the transfer of usage rights is aborted.

5. The method of claim 1, wherein step (c) includes, after transmitting the request, setting the second status indication to indicate that the transfer of the usage rights has been requested.

6. The method of claim 5, wherein the step (c) of transmitting the request includes transmitting a request message from the second content player application to the first content player application, the message including the value of the second status indication.

7. The method of either one of claims 5 or 6, further including the step (g) of determining if the transfer of rights was aborted by checking the values of the first and second status indications to establish if the second content player application has requested the usage rights and the first content player application is no longer entitled to exercise the usage rights.

8. The method of claim 1, wherein a plurality of status indications are associated with each of said first and second content player applications, corresponding with a plurality of digital licenses.

9. The method of claim 8, further including the step (h) of computing an authentication code that is a function of the values of the respective status indicators associated with each of the first and second content player applications each time a status indication associated with the corresponding content player applications is altered.

10. The method of claim 9, wherein the authentication code is computed as a one-way hash function of all of the respective status indication values.

11. The method of claim 10, further including the step (i) of associating a secret key with each one of said first and second content player applications, wherein the authentication code is computed as a function of the corresponding status indication values and said secret key.

12. The method of claim 11, wherein the authentication code is computed as a function of the corresponding status indication values and the current value of a secure monotonic counter associated with the respective content player application, said counter being incremented each time any status indication is altered.

13. The method of claim 1, wherein the step (e) of transmitting a response includes transmitting the digital license from the first player application to the second player application.

14. The method of claim 13, wherein the digital license includes a validated portion including characteristic information of a digital content decryption key that is required for decrypting the digital content, and an unvalidated portion including the digital content decryption key encrypted using an encryption key associated with the first digital content player application, and wherein transmitting the digital license from the first player application to the second player application includes the steps of:
(j) decrypting the digital content decryption key using a decryption key associated with the first digital content player application;
(k) using the decrypted digital content decryption key to generate the characteristic information of the digital content decryption key;
(l) verifying that the generated characteristic information matches the characteristic information included in the validated portion of the first digital license; and
if the verification is successful, (m) encrypting the digital content decryption key using an encryption key associated with said second digital content player application and including said encrypted key in the unvalidated portion of the digital license to be transmitted to the second player application.

15. In a digital rights management system in which a digital license confers predetermined usage rights in relation to a digital content, a system for transferring the usage rights from a first content player application to a second content player application, including:
request transmitting means adapted to transmit a request for transfer of the usage rights from the second player application to the first player application;
first indication setting means adapted to set a first status indication associated with said first content player application to indicate that the first player application is no longer entitled to exercise the usage rights;
response transmitting means adapted to transmit a response transferring the usage rights from the first player application to the second player application; and
second indication setting means adapted to set a second status indication associated with said second content player application to indicate that the second application is henceforth entitled to exercise the usage rights.

16. The system of claim 15, including first and second content player devices, wherein the first device includes said first indication setting means and said response transmitting means, and the second device includes said request transmitting means and said second indication setting means.

17. The system of claim 15, further including:
request receiving means adapted to receive a request for transfer of the usage rights transmitted from the second player application at the first player application; and
response receiving means adapted to receive a response transferring the usage rights transmitted from the first player application at the second player application.

18. The system of claim 15, further including a timer arranged to measure a predetermined time-out period following the transmission of a request for transfer of the usage rights from the second player application, and whereby the system is adapted to abort the transfer of usage rights if a corresponding response is not received by the response receiving means prior to the expiry of said predetermined time-out period.

19. The system of claim 15, wherein the request transmitting means is adapted to transmit a request message that includes the value of the second status indicator.

20. The system of claim 15, further including authentication code computing means adapted to compute an authentication code that is a function of the value of at least one of the first and second status indications, each time the value of the corresponding status indication is altered.

21. The system of claim 20, wherein the authentication code computing means computes the authentication code as a one-way hash function including the value of the corresponding status indication.

22. The system of claim 21, wherein the authentication code computing means computes the authentication code as a function of the value of the corresponding status indication and a secret key.

23. The system of claim 22, including secure storage for storing the value of the secret key.

24. The system of either one of claims 22 or 23, further including a secure monotonic counter associated with each of said first and second content player applications, each secure monotonic counter being incremented each time a status indication associated with the corresponding application is altered, wherein the authentication code computing means computes the authentication code as a function of the value of the corresponding status indication and the current value of the corresponding secure monotonic counter.

25. The system of claims 15, further including first and second tracking files associated respectively with said first and second content player applications, wherein the first and second status indications are implemented as transaction flags stored in said tracking files.

26. The system of claim 25, including a plurality of tracking flags corresponding with a plurality of digital licenses, wherein the transaction flags are associated with the corresponding digital licenses by using a unique license identifier stored within the license as an index in said tracking files.

27. The system of claim 15, which is implemented, at least in part, using one or more tamper resistant secure computing devices.

28. The system of claim 15, including license transmitting means adapted to transmit the digital license from the first player application to the second player application.

29. The system of claim 28, wherein the digital license includes a validated portion and an unvalidated portion, the validated portion including characteristic information of a digital content decryption key that is required to decrypt the digital content, and the unvalidated portion including the digital content decryption key encrypted using an encryption key associated with the first digital content player application, and the system further including:
digital content decrypting means adapted to decrypt the digital content decryption key using a decryption key associated with the first digital content player application;
generating means adapted to generate the characteristic information of the digital content decryption key using the decrypted digital content decryption key;
verification means adapted to verify that the generated characteristic information matches the characteristic information included in the validated portion of the first digital license; and
encryption means adapted to, if the verification is successful, encrypt the digital content decryption key using an encryption key associated with said second digital content player application and to include said encrypted key in the unvalidated portion of the digital license to be transmitted to the second digital content player application.

30-43. (canceled)

44. A digital content player device for use in a digital rights management system in which a digital license confers predetermined usage rights in relation to a digital content, the device including:
request transmitting means adapted to transmit a request for transfer of the usage rights from another device to said digital content player device;
response transmitting means adapted to transmit a response to a request for transfer of the usage rights received by said digital content player device from another device;
request receiving means for receiving a request for transfer of the usage rights by said digital content player device from another device;
response receiving means for receiving a response by said digital content player device from another device to a transmitted request for transfer of the usage rights; and
indication setting means adapted to set a status indication to indicate that said digital content player device is entitled to exercise the usage rights when the rights are transferred to the digital content player device, and to indicate that the digital content player device is not entitled to execute the usage rights when the rights have not been transferred to the digital content player device.

45. The digital content player device of claim 44, further including a timer configured to measure a predetermined time-out period following the transmission of a request for transfer of the usage rights by the request transmitting means, and wherein the digital content player device is adapted to abort the transfer of usage rights if a corresponding response is not received by the response receiving means prior to the expiry of said time-out period.

46. The digital content player device of claim 44, including authentication code computing means adapted to compute an authentication code that is a function of the value of said status indication each time the value of the status indication is altered.

47. The digital content player device of claim 46, wherein the authentication code is computed as a one-way hash function of the value of the status indication.

48.-49. (canceled)

50. The digital content player device of claim 44, further including a secure monotonic counter that is incremented each time the status indication is altered, and wherein the authentication code is computed as a function of the value of the status indication and the current value of the secure monotonic counter.

51. The digital content player device of claim 44, further including a tracking file, wherein the status indication is implemented as a transaction flag stored in said tracking file, wherein the tracking file includes a plurality of transaction flags corresponding with a plurality of digital licenses wherein each said transaction flag is associated with the corresponding digital license by using a unique license identifier stored within the license as an index in the tracking file.

52. (canceled)

53. In a digital rights management system, a method for generating a second digital license from a first digital license, wherein said first digital license confers predetermined usage rights in relation to a digital content upon a first digital content player application and said second digital license confers the usage rights upon a second digital content player application, said digital content being normally encrypted and only able to be decrypted using a digital content decryption key, the first and second digital licenses each including a validated portion and an unvalidated portion, wherein
the validated portion of the first digital license includes characteristic information of the digital content decryption key, and
the unvalidated portion of the first digital license includes the digital content decryption key encrypted using an encryption key associated with said first digital content player application,
the method including the steps of:
decrypting the digital content decryption key using a decryption key associated with the first digital content player application;
using the decrypted digital content decryption key to generate the characteristic information of the digital content decryption key;
verifying that the generated characteristic information matches the characteristic information included in the validated portion of the first digital license; and
if the verification is successful, encrypting the digital content decryption key using an encryption key associated with said second digital content player application and including said encrypted key in the unvalidated portion of the second digital license.

54. The method of claim 53, further including the step of verifying that the validated portion of the first digital license has not been altered or falsified, wherein the validated portion of the first digital license is preferably validated with a digital signature of a trusted authority, and the step of verifying that the validated portion of the first digital license has not been altered or falsified includes verifying that the digital signature is correct with respect to the trusted authority and the contents of the validated portion of the license.

55. (canceled)

56. The method of claim 54, further including the step of rejecting the digital license if the license has been altered or falsified.

57. The method of claim 53, wherein the validated portion of the first digital license includes characteristic information of the encrypted digital content, and the method includes the further steps of:
generating the characteristic information of the encrypted digital content; and
verifying that the generated characteristic information matches the corresponding information included in the validated portion of the first digital license.

58. The method of claim 53, wherein the encryption key associated with the first digital content player application is the public key of a first public/private key pair, and the step of decrypting includes using the corresponding private key to decrypt the encrypted digital content decryption key.

59. The method of claim 58, wherein the step of encrypting includes using a public key of a second public/private key pair that is associated with the second digital content player application to encrypt the digital content decryption key.

60. (canceled)

61. (canceled)

62. In a digital rights management system, an apparatus for generating a second digital license from a first digital license, wherein said first digital license confers predetermined usage rights in relation to a digital content upon a first digital content player application and said second digital license confers the usage rights upon a second digital content player application, said digital content being normally encrypted and only able to be decrypted using a digital content decryption key, the first and second digital licenses each including a validated portion and an unvalidated portion wherein
the validated portion of the first digital license includes characteristic information of the digital content decryption key, and
the unvalidated portion of the first digital license includes the digital content decryption key encrypted using an encryption key associated with said first digital content player application,
the apparatus including:
decrypting means adapted to decrypt the digital content decryption key using a decryption key associated with the first digital content player application;
generating means adapted to use the decrypted digital content decryption key to generate the characteristic information of the digital content decryption key;
verifying means adapted to verify that the generated characteristic information matches the characteristic information included in the validated portion of the first digital license; and
encrypting means adapted to check if the verification is successful, and if so then to encrypt the digital content decryption key using an encryption key associated with said second digital content player application and to include said encrypted key in the unvalidated portion of the second digital license.

63. The apparatus of claim 62, further including license verifying means adapted to verify that the validated portion of the digital license has not been altered or falsified, and wherein the validated portion of the first digital license is preferably validated with a digital signature of a trusted authority and the license verifying means is adapted to verify that the digital signature is correct with respect to the trusted authority and the contents of the validated portion of the license.

64. (canceled)

65. (canceled)

66. The apparatus of claim 62, wherein the encryption key associated with the first digital content player application is the public key of a first public/private key pair, and the decrypting means is arranged to use the corresponding private key to decrypt the digital content decryption key, and wherein the encrypting means is preferably arranged to use the public key of a second public/private key pair that is associated with the second digital content player application to encrypt the digital content decryption key.

67.-69. (canceled)

70. The Method of any one of claims 3 to 14, wherein the first content player application executes on a first player device and the second content player application executes on a second player device.

71. The system of any one of claims 17 to 29, including first and second content player devices, wherein the first device includes said first indication setting means and said response transmitting means, and the second device includes said request transmitting means and said second indication setting means.
